(19) United States
(12) Patent Application Publication
(10) Pub. No.: US 2026/0147442 A1
(43) Pub. Date: May 28, 2026

(54) INFORMATION PROCESSING APPARATUS, CONTROL METHOD, AND NON-TRANSITORY COMPUTER READABLE MEDIUM

(71) Applicant: CANON KABUSHIKI KAISHA, Tokyo (JP)

(72) Inventors: KENTARO WATANABE, Tokyo (JP); YOSUKE FUKAI, Kanagawa (JP); KENJI KAWAI, Tokyo (JP); MISAKO KATAOKA, Tokyo (JP); TOSHIYA USUI, Kanagawa (JP); TETSUJI SAITO, Kanagawa (JP)

(21) Appl. No.: 19/395,126

(22) Filed: Nov. 20, 2025

(30) Foreign Application Priority Data
Nov. 26, 2024 (JP) 2024-205311

(51) Int. Cl. G06F 3/04815; G06Q 10/02; G06T 19/00

(52) U.S. Cl. CPC G06F 3/04815; G06Q 10/02; G06T 19/00; G06T 2200/24

(57) ABSTRACT

An information processing apparatus according to the present disclosure includes one or more processors and/or circuitry configured to execute display control processing of performing control such that a VR content or a non-VR content corresponding to a selected plan is displayed on a display in accordance with a selection operation that is a user operation of selecting any one of a plurality of plans, and execute control processing of performing control such that reservation information indicating the selected plan is stored in a storage in accordance with a reservation operation that is a user operation of reserving the selected plan, wherein the reservation information further indicates whether or not the VR content corresponding to the selected plan is displayed when the reservation operation is performed.

### BACKGROUND

### Field of the Technology

The present disclosure relates to an information processing apparatus, a control method, and a non-transitory computer readable medium.

### Description of the Related Art

When a reservation for a hotel or the like is made, a user searches for a hotel plan via the Internet and reserves a desired plan. At this time, the user reserves the desired plan while referring to two-dimensional information (character information or two-dimensional image) displayed on a terminal such as a personal computer or a smartphone.

In a case where an image reflecting an interior of a hotel room or the like as wide as possible is displayed on the terminal such as the personal computer or the smartphone, it is necessary to capture the image at a wide angle of view. An image captured at a wide angle of view has perspective or the like different from an actual appearance, and thus, it is difficult for the user to grasp an actual scene of the room.

Therefore, a reservation system that provides, as a three-dimensional image, an introduction image of an accommodation facility to the user has been devised. Japanese Patent Laid-Open No. 2004-29937 describes a method for virtually experiencing movement to a destination by using a three-dimensional image at the time of reservation of various facilities associated with travel, and a method for enabling confirmation of an internal configuration and service details of an accommodation facility or the like with a three-dimensional image.

In a case where the user determines a plan (reservation plan) to be reserved by viewing the three-dimensional image, there is a high possibility that the details of the plan or the service is emphasized. In addition, in a case where the user determines the reservation plan by viewing an image that is not a three-dimensional image, there is a high possibility that the reservation plan is determined in accordance with a location of an accommodation facility or the like and price of the plan. As described above, in a case where the user determines the reservation plan, a required condition may vary depending on an image viewed at the time of determination.

However, in Japanese Patent Laid-Open No. 2004-29937, since it is assumed that the three-dimensional image is displayed, provision of a service corresponding to the condition has not been studied.

### SUMMARY

The present disclosure provides a technology for providing more appropriate services to a user.

An information processing apparatus according to the present disclosure includes one or more processors and/or circuitry configured to execute display control processing of performing control such that a VR content or a non-VR content corresponding to a selected plan is displayed on a display in accordance with a selection operation that is a user operation of selecting any one of a plurality of plans, and execute control processing of performing control such that reservation information indicating the selected plan is stored in a storage in accordance with a reservation operation that is a user operation of reserving the selected plan, wherein the reservation information further indicates whether or not the VR content corresponding to the selected plan is displayed when the reservation operation is performed.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a reservation system.

FIGS. 2A and 2B are diagrams illustrating display of a user terminal.

FIG. 3 is a flowchart illustrating an operation of a reservation management system.

FIGS. 4A and 4B are diagrams illustrating a state where a VR image is displayed on the user terminal.

FIG. 5 is a diagram illustrating a non-VR image displayed on the user terminal.

FIG. 6 is a table representing classification of image formats.

### DESCRIPTION OF THE EMBODIMENTS

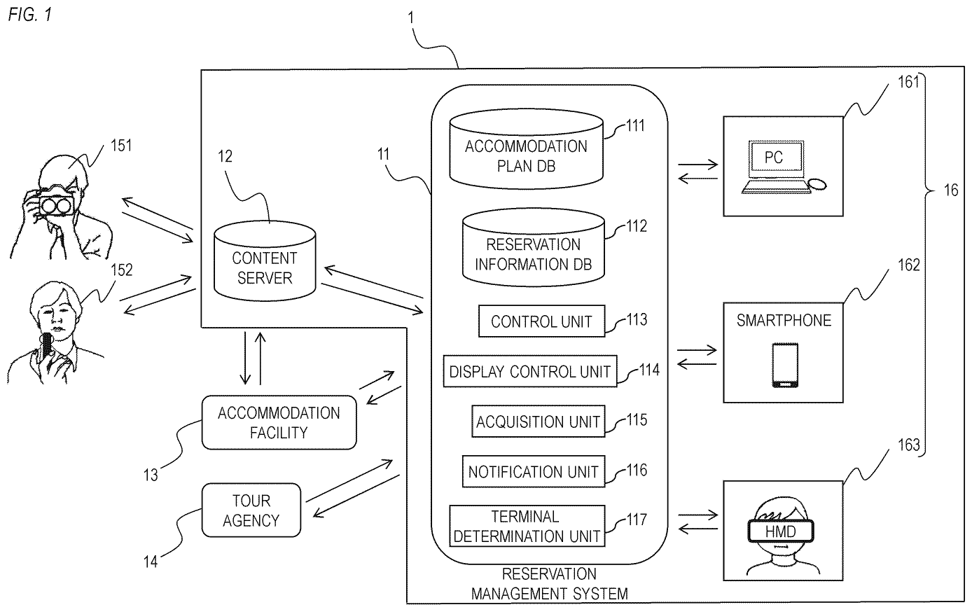

Hereinafter, an embodiment of the present disclosure will be described with reference to the drawings. FIG. 1 is an overall configuration diagram of a reservation system 1 using an information processing apparatus according to the present embodiment. The reservation system 1 includes a reservation management system 11, a content server 12, and a user terminal 16.

In the present embodiment, the reservation management system 11 is used for a user to reserve an accommodation plan. The reservation management system 11 acquires, from the content server 12, a virtual reality (VR) image regarding an interior of a room, facilities of an accommodation facility, service details such as meals, and the like. In accordance with a selection operation that is a user operation on the user terminal 16, the reservation management system 11 transmits, to the user terminal 16, the selected accommodation plan and the VR image in association with each other.

The reservation management system 11 includes an accommodation plan database (DB) 111, a reservation information database (DB) 112, a control unit 113, a display control unit 114, an acquisition unit 115, a notification unit 116, and a terminal determination unit (detection unit) 117.

The accommodation plan DB 111 is a database including a storage unit such as a storage medium. The storage unit stores information regarding an accommodation plan to be presented to the user, and the like. The accommodation plan DB 111 stores, in association with the accommodation plan, vacant information of an accommodation facility (information on whether or not an accommodation plan can be reserved), price information, information regarding an interior of a room and equipment of an accommodation facility, information regarding service details such as a meal, and the like. Various types of information stored in the accommodation plan DB 111 may include a two-dimensional image and the like. Various types of information stored in the accommodation plan DB 111 are stored by an accommodation facility 13 and a tourist agent 14. The reservation management system 11 transmits, to the user terminal 16, information on an accommodation plan that can be reserved from the accommodation plan DB 111 in accordance with a user operation on the user terminal 16.

The reservation information DB 112 is a database including a storage unit such as a storage medium. This storage unit is used to store reservation information and the like regarding the selected accommodation plan in accordance with a reservation operation that is a user operation on the user terminal 16. The reservation information includes personal information (contact information) regarding the user who has reserved the accommodation plan, information (referred to as “plan information”) regarding the accommodation plan reserved by the user, information (referred to as “surrounding information”) regarding a surrounding area regarding the accommodation plan reserved by the user, and the like.

The plan information includes a plurality of pieces of information such as an accommodation facility reserved by the user, a room, a date, a period, the number of persons to be reserved, a price of the reserved plan, and service details (such as dish) regarding the reserved plan. The plurality of pieces of information included in the plan information are associated with a plurality of VR images or non-VR images associated with each piece of information.

The surrounding information includes a plurality of pieces of information such as tourism information around the accommodation facility, route information to the accommodation facility, and information regarding transportation method to the accommodation facility. The plurality of pieces of information included in the surrounding information are not directly related to the accommodation plan, but are useful information for the user. One or more related images (VR images or non-VR images) are associated with each of the plurality of pieces of information.

The control unit 113 controls the entire reservation management system 11. The control unit 113 performs control such that the reservation information is stored in the reservation information DB 112 in accordance with a user operation on the user terminal 16. In addition, the control unit 113 performs determination of contents to be displayed on the user terminal 16, user authentication, and the like.

The display control unit 114 performs control such that a VR image (VR content), a non-VR image (non-VR content), and the like are displayed on the user terminal 16 in accordance with a user operation on the user terminal 16. The display control unit 114 performs control such that a VR image, a non-VR image, and the like are transmitted from the accommodation plan DB 111 or the content server 12 to the user terminal 16. The display control unit 114 may perform control such that the non-VR image is displayed on the user terminal 16 by superimposing the non-VR image on the VR image.

The acquisition unit 115 acquires a VR image, a non-VR image, and the like according to a user operation on the user terminal 16. For example, the acquisition unit 115 acquires the VR image, the non-VR image, and the like from the accommodation plan DB 111 and the content server 12.

The notification unit 116 provides notification regarding confirmation of a reservation and the like to a contact address of the user registered by the user and the accommodation facility 13 (or the tourist agent 14) by e-mail and the like. After a reservation operation, the notification unit 116 may issue a notification prompting the user to store the VR image in the content server 12 on the basis of the reservation information.

The terminal determination unit 117 determines a type of the user terminal 16 connected to the reservation management system 11. The terminal determination unit 117 determines the type of the user terminal 16 by acquiring information (terminal type information) regarding the type of terminal transmitted from the user terminal 16.

The content server 12 is a server including a storage unit such as a storage medium. The storage unit stores information regarding the interior of the room of the accommodation facility and service details such as equipment and meals. The various types of information stored in the content server 12 may include a non-VR image, an image that is a three-dimensional image and is also a 180-degree image (3D 180-degree image), an image that is a three-dimensional image and is also a 360-degree image (3D 360-degree image), and the like. In the content server 12, information may be stored by a person in charge of the accommodation facility 13 or one or a plurality of image capturing persons (photographers).

In the present embodiment, the 3D 180-degree image and the 3D 360-degree image are images in which a real space is captured by using a plurality of fisheye lenses arranged in parallel. The 3D 180-degree image is a type of three-dimensional image obtained by capturing a space in front of a camera and having a horizontal angle of view of about 180 degrees. In addition, the 3D 360-degree image is a type of three-dimensional image obtained by capturing a space of 360 degrees. Each of the 3D 180-degree image and the 3D 360-degree image include two images having parallax. One of the two images corresponds to a right eye of the user, and the other corresponds to a left eye of the user. The user views the 3D 180-degree image and the 3D 360-degree image on which predetermined processing is performed by using image editing software and the like on the corresponding HMD. As a result, since the user can view an object stereoscopically, the user can view the object while obtaining a sense of immersion.

In general, it is said that an effective field of view that can be consciously viewed by a human at a time is about 60 degrees to 70 degrees horizontally in front, and in the present embodiment, an image obtained by capturing a range exceeding this range is the 3D 180-degree image. However, the 3D 180-degree image is not limited to an image obtained by strictly capturing the space having the horizontal angle of view of 180 degrees, and may be, for example, an image having a horizontal angle of view of 190 degrees, 220 degrees, or 140 degrees. A head mounted display (HMD) is used, and thus, the user can view a region captured beyond the effective field of view, of the images captured as the 3D 180-degree image and the 3D 360-degree image, by moving the head or a line of sight.

The user may be able to view one image of the two images having parallax captured as the 3D 180-degree image or the 3D 360-degree image. One image of the two images having parallax may be an image (2D 180-degree image) that is a two-dimensional image and is also a 180-degree image or an image that is a two-dimensional image and is also a 360-degree image (2D 360-degree image). In a case where the user views the 2D 180-degree image and the 2D 360-degree image by using the HMD, it is not possible to obtain a stereoscopic effect, but it is possible to confirm as if the user looks around. In a case where the 2D 180-degree image and the 2D 360-degree image are viewed on a terminal that displays a two-dimensional image, such as a personal computer or a smartphone, a viewpoint can be changed by a user operation. In such a case, the user cannot obtain a sense of immersion. On the other hand, in this case, the amount of information obtained by the user from the image is larger than that of a simple two-dimensional image.

In the present embodiment, the 3D 180-image, the 3D 360-degree image, the 2D 180-degree image, and the 2D 360-degree image are collectively referred to as VR images. The VR image may be a still image or a moving image. Since the VR image has a larger amount of information than the simple two-dimensional image, a bandwidth of a network may be pressed when the VR image is downloaded to the user terminal 16. Thus, the VR image is required to be transmitted to an appropriate target at an appropriate timing.

The VR image stored in the content server 12 is not limited to being stored by the person in charge of the accommodation facility 13. The content server 12 may store VR images by one or a plurality of image capturing persons 151 and 152. The image capturing persons 151 and 152 may be, for example, guests of the accommodation facility 13, and may store VR images of interiors of rooms in which the image capturing persons 151 and 152 actually stayed or meals, in association with a reserved accommodation plan. As described above, the person who stores the VR images in the content server 12 is not limited to the person in charge of the accommodation facility 13. As a result, even in a case where the person in charge of the accommodation facility 13 does not capture the VR images regarding the own facility, it is possible to expect acquisition of high-quality VR images by a plurality of guests who have high literacy with respect to the VR images.

The user terminal 16 can be connected to the reservation management system 11 through a network such as the Internet, and is a terminal having a display unit. In the present embodiment, as the user terminal 16, a terminal capable of displaying two-dimensional images of a personal computer 161 and a smartphone 162, a terminal capable of displaying three-dimensional VR images such as an HMD 163, and the like are connected to the reservation management system 11. However, the user terminal 16 may be any terminal that can be connected to a network, can display an image, and can perform a user operation.

When the user terminal is connected to the reservation management system 11, the user terminal 16 transmits the terminal type information and the like to the reservation management system 11. The reservation management system 11 receives the terminal type information and identification information to be described later, which are transmitted from the user terminal 16. The reservation management system 11 changes an image format to be displayed on the user terminal 16 on the basis of an operation of the user terminal 16. The user terminal 16 displays the non-VR image and the VR image transmitted from the reservation management system 11 on the display unit.

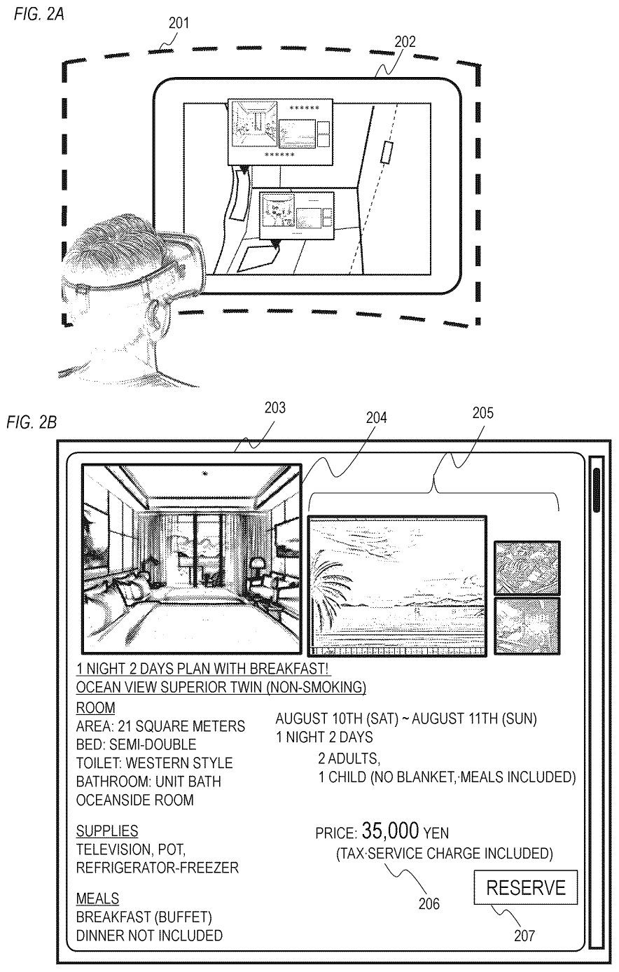

Next, a flow in which the user reserves the accommodation plan by using the HMD 163 (user terminal 16) will be described with reference to FIGS. 2A to 6. FIGS. 2A and 2B are diagrams illustrating display of the HMD 163. In FIG. 2A, the user wearing the HMD 163 is viewing a screen displayed on the HMD 163. A frame 201 indicated by a broken line in FIG. 2A indicates a range visually recognizable by the user wearing the HMD 163. A search screen 202 displays a plurality of accommodation facilities selectable by the user. The non-VR image is displayed on the search screen 202 so as to indicate a location of the accommodation facility on a map. In a case where the user uses the personal computer 161, the smartphone 162, or the like, the search screen 202 is displayed on the display unit.

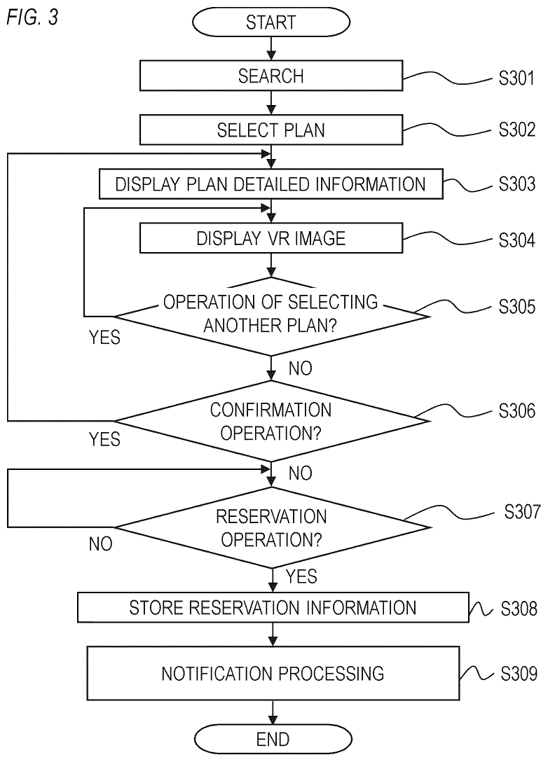

FIG. 3 is a flowchart illustrating an operation of the reservation management system 11 when the user reserves a plan by using the HMD 163. The processing of this flowchart starts when “the user has access to the reservation management system 11 by using the HMD 163 and inputs information such as an accommodation date and time, the number of people, and an accommodation place while viewing the search screen 202”.

In S301, the control unit 113 searches the accommodation plan DB 111 for a plan that matches search conditions, among plans that can be reserved. The display control unit 114 causes the HMD 163 to display results of the search by the control unit 113 from the accommodation plan DB 111. The search results displayed on the HMD 163 may be, for example, two-dimensional information indicating details of a main plan (price, plan name, and the like) while indicating places of accommodation facilities as candidates on the map. Note that, when the search result is displayed, the user performs a user operation (selection operation) of selecting any plan close to desired condition from a plurality of displayed plans (search results).

In S302, the control unit 113 selects a plan corresponding to the selection operation.

In S303, the display control unit 114 causes the HMD 163 to display detailed information regarding the plan selected in S302. In the HMD 163, as illustrated in FIG. 2B, a detailed screen 203 showing various types of information of the plan selected by the selection operation is displayed as two-dimensional information on the HMD 163.

The detailed screen 203 includes information such as a size of a room and a bed size regarding the plan selected in S302. The detailed screen 203 includes a two-dimensional thumbnail 204, a two-dimensional thumbnail 205, price information 206, and a reservation button 207. The two-dimensional thumbnail 204 shows an interior of a room. The two-dimensional thumbnail 205 shows a scene such as a view from a room, a meal, and an open-air bath. The reservation button 207 is a button for making a reservation. Here, it is assumed that the user selects the two-dimensional thumbnail 204 in order to obtain detailed information regarding the interior of the room for the selected plan.

In S304, the display control unit 114 causes the HMD 163 to display the VR image corresponding to the two-dimensional thumbnail 204. Thus, first, when the control unit 113 detects a user operation of selecting the two-dimensional thumbnail 204 of the user, the terminal determination unit 117 acquires the terminal type information. The display control unit 114 transmits an image in an image format corresponding to the terminal type information (terminal) to the user terminal 16. In the present embodiment, since the user is having access to the reservation management system 11 by using the HMD 163, the display control unit 114 transmits the VR image of the interior of the room from the content server 12 to the HMD 163. As a result, the display control unit 114 controls the display unit of the HMD 163 to display the VR image of the interior of the room. Accordingly, the user can confirm the VR image by using the HMD 163.

The VR images have image formats such as the 3D 180-degree images, the 3D 360-degree images, the 2D 180-degree images, and the 2D 360-degree images. However, the image formats of the VR images stored in the content server 12 by the accommodation facility 13 and the image capturing persons 151 and 152 may not be unified. Thus, the image formats of the images associated with each plan may be different depending on the plan. In the present embodiment, a description will be given on the assumption that the 3D 180-degree images are associated with the plan selected by the user.

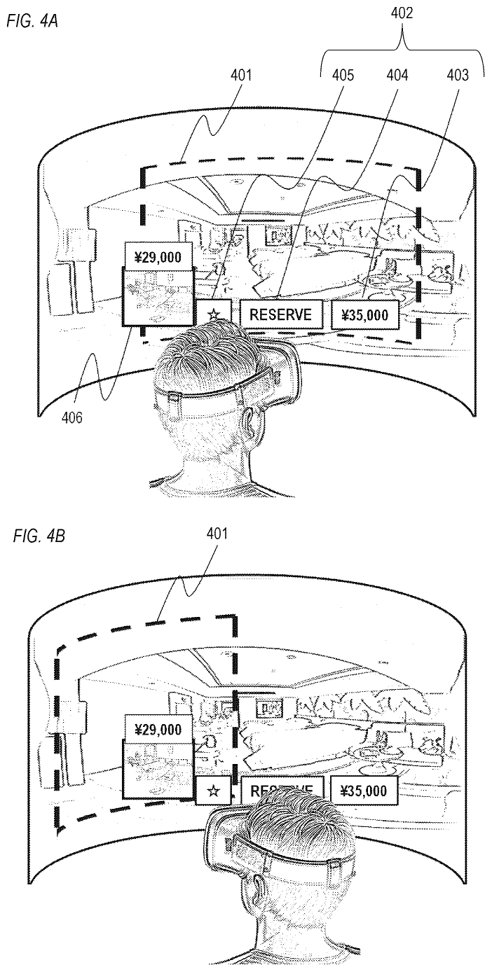

FIGS. 4A and 4B are diagrams illustrating a state where the VR image that is the interior of the room is displayed on the HMD 163. In FIGS. 4A and 4B, a frame 401 indicated by a broken line indicates a field of view range of the HMD 163, and indicates a range of the VR image viewed by the user. In the HMD 163, the range to be displayed in the VR image is changed such that the frame 401 moves in accordance with the movement of the user changing a direction of the head. For example, in a case where the user viewing the image of the frame 401 illustrated in FIG. 4A turns their head to the left, the range to be displayed in the VR image is changed as illustrated in FIG. 4B. In the present embodiment, since the VR image displayed on the HMD 163 is the 3D 180-degree image, it is possible to obtain a feeling as if the user is in a room and looking around.

The display control unit 114 may display the non-VR image corresponding to the plan selected on the basis of the selection operation so as to be superimposed on the VR image displayed on the HMD 163. In the present embodiment, price information 403, a reservation button 404, and a registration button 405 are displayed so as to be superimposed on the VR image of the interior of the room. The price information 403 indicates the price information of the selected plan. The reservation button 404 is a button for making a reservation for the selected plan. The registration button 405 is a button for performing favorite registration such that the selected plan can be later compared with another plan. The price information 403, the reservation button 404, and the registration button 405 are collectively referred to as superimposed two-dimensional information 402.

The display control unit 114 may display a non-VR image corresponding to a plan (other plan) different from the plan selected on the basis of the selection operation so as to be superimposed on the VR image displayed on the HMD 163. In the present embodiment, a two-dimensional thumbnail 406 is superimposed (displayed) such that the selected plan can be easily compared with the other plan. The two-dimensional thumbnail 406 is a thumbnail image of the VR image (3D 180-degree image) corresponding to the other plan. The user can view the VR image corresponding to the other plan by selecting the two-dimensional thumbnail 406. The other plan may be a plan for using another room of the same accommodation facility 13 or a plan for using another accommodation facility.

In S305, the control unit 113 determines whether or not the user performs an operation (referred to as an “other plan selection operation”) of selecting the other plan (a plan different from the plan selected in S302). The processing returns to S304 in a case where the control unit 113 determines that the user performs the other plan selection operation, and the processing proceeds to S306 in a case where the control unit 113 determines that the user does not perform the other plan selection operation.

In the present embodiment, when the other plan selection operation is performed, the user selects the two-dimensional thumbnail 406 by using a hand gesture, a controller attached to the HMD 163, or the like. When the control unit 113 determines that the other plan selection operation is performed, the display control unit 114 performs control such that the VR image corresponding to the plan that the user has been watching so far is switched to the VR image corresponding to the other plan and the switched VR image is displayed. At this time, the price information 403 displayed on the HMD 163 is also switched. After the display to the VR image corresponding to the other plan is switched, the two-dimensional thumbnail 406 displayed so as to be superimposed on the VR image is the thumbnail of the VR image corresponding to the room of the plan selected in S302. As a result, the user can easily compare VR images corresponding to a plurality of plans, the user can easily compare the plans.

In S306, the control unit 113 determines whether or not the user performs a user operation (referred to as a “confirmation operation”) for confirming various types of information corresponding to the plan selected in S305. In a case where the control unit 113 determines that the user performs the confirmation operation, the processing returns to S303, and in a case where the control unit determines that the user does not perform the confirmation operation, the processing proceeds to S307.

The superimposed two-dimensional information 402 and the two-dimensional thumbnail 406 may be displayed so as to be superimposed on a position (position close to the user side) in front of the VR image in order to improve visibility. For example, the superimposed two-dimensional information 402 and the two-dimensional thumbnail 406 are displayed at a place virtually 40 cm away from the user. In addition, the 3D 180-degree image of the interior of the room may be captured such that a closest object is arranged 50 cm or more away from the user.

In S307, the control unit 113 determines whether or not the user performs a user operation (reservation operation) for reserving the selected plan. In a case where the control unit 113 determines that the user performs the reservation operation, the processing proceeds to S308, and in a case where the control unit determines that the user does not perform the reservation operation, the control unit waits until the reservation operation is performed. The user determines whether to make a reservation by comparing the plans while switching a plurality of VR images corresponding to the plurality of plans. When the user selects the reservation button 404, the HMD 163 displays a reservation screen for the selected plan. The reservation screen includes two-dimensional information. After personal information and payment information regarding the user are input on the reservation screen, when the reservation is confirmed on a final confirmation screen, the contract is established.

In S308, the control unit 113 stores reservation information on the basis of a user operation or the like on the HMD 163 in the reservation information DB 112. The reservation information is information in which personal information, identification information, plan information, and surrounding information regarding the user are associated (information including these pieces of information). In a case where the HMD 163 can acquire pieces of biological information such as iris information, blood pressure information, and heart rate information of the user, the control unit 113 may associate at least one of various types of information included in the biological information with the personal information regarding the user. The biological information may be fingerprint information, voiceprint information, or the like.

The identification information is information on the image format of the image viewed when the user performs the reservation operation. For example, the information regarding the image format includes information indicating whether the image viewed by the user is the non-VR image or the VR image. In addition, in a case where the image viewed by the user is the VR image, the information regarding the image format includes information regarding the format of the VR image, and the like. For example, in a case where the user is viewing the 3D 180-degree image at the time of the reservation operation, the fact that the user performs the reservation operation by viewing the 3D 180-degree image is recorded in the identification information.

Here, a case where the user uses the user terminal 16 capable of performing only two-dimensional display, such as the personal computer 161 or the smartphone 162, will be described. The display control unit 114 controls the user terminal 16 to display a non-VR image capable of confirming the interior of the room of the plan selected by the user in accordance with the terminal type information. In a case where both the VR image and the non-VR image are stored in the accommodation plan DB 111 or the content server 12, the display control unit 114 may transmit either the VR image or the non-VR image in accordance with the terminal type information to the user terminal 16. In a case where the user selects the two-dimensional thumbnail 204, the display control unit 114 transmits a non-VR image corresponding to the interior of the room of the plan selected by the user to the user terminal 16.

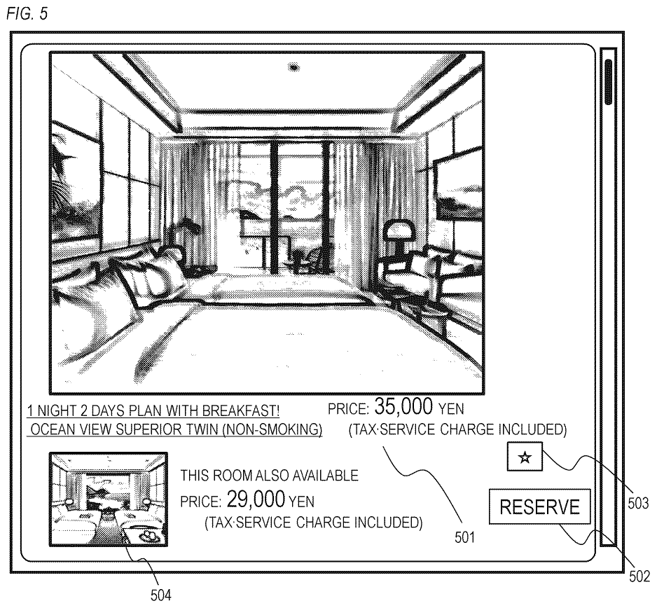

FIG. 5 is a diagram illustrating a state where the non-VR image representing the interior of the room is displayed on a display unit of the personal computer 161 or the smartphone 162. On this display unit, price information 501, a reservation button 502, and a registration button 503 are displayed as two-dimensional information. The price information 501 indicates price information of the selected plan. The reservation button 502 is a button for making a reservation for the selected plan. The registration button 503 is a button for performing favorite registration such that the selected plan can be later compared with another plan. Various pieces of two-dimensional information are displayed so as not to be superimposed on the non-VR image corresponding to the interior of the room. In addition, a two-dimensional thumbnail 504 is displayed such that the selected plan can be easily compared with the other plan. The two-dimensional thumbnail 504 is a thumbnail image of an image corresponding to an interior of a room of the other plan. The two-dimensional thumbnail 504 is displayed so as not to be superimposed on the non-VR image corresponding to the interior of the room. The user can view the image corresponding to the other plan by selecting the two-dimensional thumbnail 504. Since a flow until the reservation is confirmed is similar to a case where the VR image is viewed by the HMD 163, the description thereof is omitted. The fact that the user performs the reservation operation by viewing the non-VR image is recorded in the identification information associated with the reservation information.

The description refers back to FIG. 3. In S309, the notification unit 116 performs notification processing of notifying a contact address of the user registered by the user of the confirmation of the reservation by e-mail or the like on the basis of the reservation information. In addition, the notification unit 116 notifies the accommodation facility 13 or the tourist agent 14 of the confirmation of the reservation by e-mail or the like on the basis of the reservation information. In the e-mail, a link (URL) to the reservation information is described, and when the link is selected, the user can confirm their reservation details. In a case where the user confirms their reservation details by using a link to the reservation information or the like after the reservation operation, the control unit 113 determines the image format of the information to be displayed on the user terminal 16 on the basis of the terminal type information of the user terminal 16 and the reservation information.

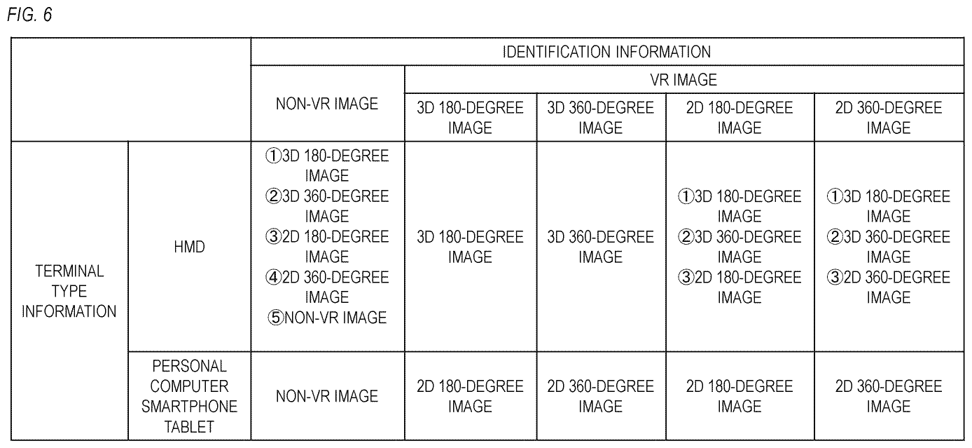

FIG. 6 is a table illustrating classification of image formats. FIG. 6 illustrates which image format the reservation management system 11 presents information to the user who confirms the reservation details after the reservation operation. Which image format the reservation management system 11 presents the information is determined on the basis of the terminal type information used by the user and the identification information associated with the reservation information. Numbers 1 to 5 illustrated in FIG. 6 indicate priority orders of the image formats presented by the reservation management system 11. In a case where there is “the image stored in the content server 12 after the reservation operation of the user and associated with the plan reserved by the user”, the reservation management system 11 may present a new image according to the priority orders illustrated in FIG. 6.

Here, a case where the user connects the user terminal 16 to the reservation management system 11 in order to confirm the reservation details after the reservation operation will be described. First, a case where the user viewing the non-VR image at the time of reservation operation connects to the reservation management system 11 from the personal computer 161 will be described. In this case, the control unit 113 determines a degree of request for the VR image of the user and the literacy for the VR image on the basis of the terminal type information and the identification information. In this case, since the personal computer 161 that is not suitable for viewing the VR image is used, the control unit 113 determines that the degree of request of the user for the VR image is not high. In addition, since the VR image is not viewed at the time of the reservation operation, the control unit 113 determines that the literacy of the user with respect to the VR image is not high. Thus, when it is determined that it is less necessary to show the VR image to the user and presenting the plan information or the surrounding information associated with the reservation information to the user, the display control unit 114 transmits the non-VR image to the personal computer 161.

A case where the user viewing the non-VR image at the time of the reservation operation connects from the HMD 163 to the reservation management system 11 to confirm the reservation details will be described. In this case, the control unit 113 determines the degree of request for the VR image of the user and the literacy for the VR image on the basis of the terminal type information and the identification information. In this case, since the HMD 163 suitable for viewing the VR image is used, the control unit 113 determines that the degree of request for the VR image is high. On the other hand, since the VR image is not viewed at the time of the reservation operation, the control unit 113 determines that the literacy of the user with respect to the VR image is not high. Thus, the control unit 113 determines that there is a possibility that the user does not want the VR image at the time of the reservation operation but want an image having a larger amount of information than the non-VR image at a present point in time. Thus, the display control unit 114 determines that there is a certain degree of necessity to show the VR image to the user, and transmits a VR image having a highest priority order among one or more VR images to the HMD 163 in a case where the one or more VR images are associated with the reserved plan. In a case where the VR image is not associated with the reserved plan, the display control unit 114 transmits the non-VR image to the HMD 163.

A case where the user viewing the VR image at the time of the reservation operation connects from the personal computer 161 to the reservation management system 11 to confirm the reservation details will be described. In this case, the control unit 113 determines the degree of request for the VR image of the user and the literacy for the VR image on the basis of the terminal type information and the identification information. In this case, since the personal computer 161 that is not suitable for viewing the VR image is used, the control unit 113 determines that the degree of request of the user for the VR image is not high. However, although the terminal capable of performing only the two-dimensional display is used, since the user views the VR image at the time of the reservation operation, the control unit 113 determines that the user has high literacy regarding the VR image. Thus, the display control unit 114 determines that there is a certain degree of necessity to show the VR image to the user, and transmits the 2D 180-degree image or the 2D 360-degree image to the personal computer 161.

A case where the user viewing the VR image at the time of the reservation operation connects from the HMD 163 to the reservation management system 11 to confirm the reservation details will be described. In this case, the control unit 113 determines the degree of request for the VR image of the user and the literacy for the VR image on the basis of the terminal type information and the identification information. In this case, since the HMD 163 suitable for viewing the VR image is used, the control unit 113 determines that the degree of request of the user for the VR image is high. Further, since the VR image is viewed at the time of the reservation operation, the control unit 113 determines that the user has high literacy for the VR image. Thus, the display control unit 114 determines that there is a certain degree of necessity to show the VR image to the user, and transmits the 3D 180-degree image or the 3D 360-degree image to the HMD 163 in a case where the 3D VR image is associated with the reserved plan. In a case where the 3D VR image is not associated with the reserved plan, the display control unit 114 transmits the 2D 180-degree image or the 2D 360-degree image to the HMD 163.

The notification unit 116 (reservation management system 11) may issue “a notification requesting to capture the VR image to post (store) the VR image to the content server 12” for the user determined to have viewed the VR image at the time of the reservation operation on the basis of the identification information. The notification for the user is for prompting the capturing of the VR image regarding the interior of the accommodation facility 13, the service details, or the like. By issuing such a notification, the person in charge of the accommodation facility 13 can expect acquisition of a high-quality VR image by the guest having high literacy with respect to the VR image without capturing the VR image regarding the own facility.

In addition, in a case where the biological information of the user is included in the reservation information, the reservation management system 11 may perform user authentication using the biological information when the user confirms their reservation details. For example, in a case where the HMD 163 acquires the iris information of the user, the reservation management system 11 may perform the user authentication by using the iris information. Among the pieces of biological information, information such as the blood pressure information and the heart rate information can be used to estimate information that the user would be most interested in at the time of the reservation operation. For example, in a case where it is estimated that the user is most interested in the VR image regarding the food at the time of the reservation operation, when the user confirms reservation details after the reservation operation, the VR image regarding the dish corresponding to the reserved plan may be presented first.

As described above, the reservation management system 11 causes the user terminal 16 to display the search screen 202, the superimposed two-dimensional information 402, and the two-dimensional thumbnail 406, as the two-dimensional information. In addition, since the reservation management system 11 causes the user terminal 16 to display only the interior of the room or the like as the VR image, it is possible to suppress the pressure on the network bandwidth due to the transmission of the VR image. In addition, the identification information (reservation information) indicating whether the VR image (VR content) corresponding to the plan selected when the reservation operation is performed is displayed is stored in the reservation information DB 112. Thus, for example, when the user confirms the reservation details after the reservation operation, the reservation management system 11 can determine whether the user is the user viewing the non-VR image or the user viewing the VR image at the time of the reservation operation on the basis of the identification information. The reservation management system 11 can transmit the VR image to an appropriate target in accordance with the identification information. That is, it is possible to provide the VR image to the user who wants to view the VR image and not to provide an unnecessary VR image to the user who does not want to view the VR image. Accordingly, a more appropriate service can be provided to the user. In addition, even though the user terminal 16 is different from that at the time of the reservation operation, since the image format can be appropriately transmitted to the user terminal 16, it is possible to reduce the pressure on the bandwidth of the network.

Note that, in the above embodiment, the reservation management system 11 controls whether or not to transmit the VR image to the user after the reservation operation on the basis of the reservation information, but may perform another control on the basis of the reservation information. For example, the reservation management system 11 may preferentially introduce a plan similar to an appearance of the room or facility in the plan of the previous reservation to the user viewing the VR image at the time of the reservation operation, at the time of a next plan search. This is because the user confirms rooms and facilities in more detail by viewing the VR image and there is a possibility that the user is interested in these rooms and facilities. On the other hand, the reservation management system 11 may preferentially introduce a plan with the amount of money similar to the amount of money of the plan of the previous reservation to the user who is not viewing the VR image at the time of the reservation operation, at the time of the next plan search. This is because the user does not watch the VR image and thus does not confirm the room or facility in more detail, and there is a possibility that the user is attracted to the price of the plan and makes a reservation. As described above, when the identification information (reservation information) is stored in the reservation information DB 112, the reservation management system 11 can then provide a service more suitable for the user.

In the present embodiment, although it has been described that the reservation management system 11 is a system for allowing the user to reserve the accommodation plan, the present disclosure is not limited thereto. For example, the reservation management system 11 may be a system for allowing the user to reserve a ticket for a concert or the like, or a system for allowing the user to purchase an article. In addition, in the present embodiment, although it has been described that the information processing apparatus is the reservation management system 11, the user terminal 16 may be an information processing apparatus including a control unit, a display control unit, an acquisition unit, a notification unit, a detection unit, and the like. In this case, the reservation management system 11 may be a server having only the accommodation plan DB 111 and the reservation information DB 112.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205311, filed Nov. 26, 2024, which is hereby incorporated by reference herein in its entirety.

What is claimed is:

1. An information processing apparatus comprising:
one or more processors and/or circuitry configured to
execute display control processing of performing control such that a VR content or a non-VR content corresponding to a selected plan is displayed on a display in accordance with a selection operation that is a user operation of selecting any one of a plurality of plans, and
execute control processing of performing control such that reservation information indicating the selected plan is stored in a storage in accordance with a reservation operation that is a user operation of reserving the selected plan,
wherein the reservation information further indicates whether or not the VR content corresponding to the selected plan is displayed when the reservation operation is performed.

2. The information processing apparatus according to claim 1, wherein the VR content is in a format of any one of an image that is a three-dimensional image and is also a 180-degree image, an image that is a three-dimensional image and is also a 360-degree image, an image that is a two-dimensional image and is also a 180-degree image, and an image that is a two-dimensional image and is also a 360-degree image.

3. The information processing apparatus according to claim 1, wherein the one or more processors and/or circuitry further executes acquisition processing of acquiring the VR content or the non-VR content corresponding to the selected plan in accordance with the selection operation.

4. The information processing apparatus according to claim 3, wherein the VR content is a VR image captured by one or a plurality of photographers.

5. The information processing apparatus according to claim 1, wherein the reservation information includes biological information of the user.

6. The information processing apparatus according to claim 5, wherein the biological information includes at least one of iris information, blood pressure information, and heart rate information.

7. The information processing apparatus according to claim 5, wherein, in a case where the user refers to the reservation information stored in the storage, in the control processing, user authentication is performed on a basis of the biological information.

8. The information processing apparatus according to claim 5, wherein in the control processing, a content to be displayed after the reservation operation, of the VR content and the non-VR content is determined on a basis of the reservation information including the biological information.

9. The information processing apparatus according to claim 1, wherein in the display control processing, control is performed such that the VR content or the non-VR content is transmitted from a content server in which the VR content or the non-VR content is stored to a user terminal including the display.

10. The information processing apparatus according to claim 9,
wherein the one or more processors and/or circuitry further executes detection processing of detecting a type of the user terminal, and
in a case where both the VR content and the non-VR content are stored in the content server, in the display control processing, control is performed such that any one of the VR content and the non-VR content is transmitted to the user terminal on a basis of the type of the user terminal.

11. The information processing apparatus according to claim 9,
wherein the reservation information further includes contact information of a user, and
the one or more processors and/or circuitry further executes notification processing of issuing, to a contact address on a basis of the contact information, a notification prompting the user to store a new VR content related to the selected plan in the content server in a case where the reservation information indicates that the VR content is displayed.

12. The information processing apparatus according to claim 1, wherein in the display control processing, a two-dimensional image corresponding to the selected plan is displayed on the display by superimposing the two-dimensional image on the VR content.

13. The information processing apparatus according to claim 12,
wherein in the display control processing, a two-dimensional image corresponding to a second plan different from a first plan that is the selected plan is caused to be displayed on the display in a superimposed manner on a first VR content corresponding to the first plan, and
in the display control processing, a second VR content corresponding to the second plan is caused to be displayed on the display in a case where a user performs a selection operation to select the second plan.

14. A control method of an information processing apparatus, comprising:
performing control such that a VR content or a non-VR content corresponding to a selected plan is displayed on a display in accordance with a selection operation that is a user operation of selecting any one of a plurality of plans; and
performing control such that reservation information indicating the selected plan is stored in a storage in accordance with a reservation operation that is a user operation of reserving the selected plan,
wherein the reservation information further indicates whether or not the VR content corresponding to the selected plan is displayed when the reservation operation is performed.

15. A non-transitory computer readable medium that stores a program, wherein the program causes a computer to execute a control method of an information processing apparatus, the control method comprising:
performing control such that a VR content or a non-VR content corresponding to a selected plan is displayed on a display in accordance with a selection operation that is a user operation of selecting any one of a plurality of plans; and
performing control such that reservation information indicating the selected plan is stored in a storage in accordance with a reservation operation that is a user operation of reserving the selected plan,
wherein the reservation information further indicates whether or not the VR content corresponding to the selected plan is displayed when the reservation operation is performed.
